(19) United States
(12) Patent Application Publication
(10) Pub. No.: US 2026/0133358 A1
(43) Pub. Date: May 14, 2026

(54) ILLUMINATION DEVICE AND DISPLAY DEVICE

(71) Applicant: Magnolia White Corporation, Tokyo (JP)

(72) Inventors: Koji FUJISAWA, Tokyo (JP); Ken KAGABU, Tokyo (JP); Koichi OKUDA, Tokyo (JP); Hiroaki KIJIMA, Tokyo (JP)

(73) Assignee: Magnolia White Corporation, Tokyo (JP)

(21) Appl. No.: 19/387,672

(22) Filed: Nov. 13, 2025

(30) Foreign Application Priority Data
Nov. 13, 2024 (JP) 2024-197807

(51) Int. Cl. F21V 8/00

(52) U.S. Cl. CPC G02B 6/0045; G02B 6/0031; G02B 6/0053; G02B 6/0068; G02B 6/0076; G02B 6/0091

(57) ABSTRACT

According to an embodiment, in an illumination device, a first surface of a first light guide includes a plurality of first protruding portions formed thereon. A second surface includes a plurality of second protruding portions formed thereon. Each of the plurality of first protruding portions has a cross-sectional shape of a first triangle projecting downward, and, has a first base angle, a second base angle, and a first apex angle. Each of the plurality of second protruding portions has a cross-sectional shape of a second triangle projecting upward, and, has a third base angle, a fourth base angle, and a second apex angle. The third base angle is larger than the first base angle.

### CROSS-REFERENCE TO RELATED APPLICATIONS

This application is based upon and claims the benefit of priority from Japanese Patent Application No. 2024-197807, filed Nov. 13, 2024, the entire contents of which are incorporated herein by reference.

### FIELD

Embodiments described herein relate generally to an illumination device and a display device.

### BACKGROUND

Illumination devices for illuminating display panels have been developed.

### BRIEF DESCRIPTION OF THE DRAWINGS

FIG. 1 is a perspective view schematically showing a configuration of a display device according to an embodiment.

FIG. 2 is a plan view schematically showing the configuration of the display device.

FIG. 3 is a cross-sectional view showing a sectional configuration of the display device taken along the line A1-A2 in FIG. 2.

FIG. 4 is a cross-sectional view schematically showing a configuration of an illumination device of a comparative example.

FIG. 5 is a cross-sectional view showing a protruding portion provided on a light guide LGL.

FIG. 6 is a cross-sectional view schematically showing a configuration of an illumination device of the embodiment.

FIG. 7 is a cross-sectional view showing a protruding portion provided on the light guide LGL.

FIG. 8 is a cross-sectional view showing another configuration example of the illumination device in the embodiment.

FIG. 9 is a cross-sectional view showing a protruding portion provided on the light guide LGL.

FIG. 10 is a cross-sectional view showing another configuration example of the illumination device in the embodiment.

FIG. 11 is a cross-sectional view showing a protruding portion provided on the light guide LGL.

FIG. 12 is a plan view illustrating an application example of the illumination device.

FIG. 13 is a cross-sectional view showing a cross-sectional configuration of the display device taken along the line B1-B2 in FIG. 12.

FIG. 14 is a perspective view showing an example of an appearance of a display device according to Configuration Example 3.

### DETAILED DESCRIPTION

In general, according to one embodiment, an illumination device comprises
a first light guide including a first edge and a second edge;
a second light guide disposed on the first light guide and including a third edge and a fourth edge;
a plurality of light source elements disposed to face the third edge of the second light guide;
a reflector provided below the first light guide; and
an optical sheet provided on the second light guide,
wherein
the first light guide has a cross-sectional shape of a first trapezoid whose lower base thereof is shorter than an upper base,
the second light guide has a cross-sectional shape of a second trapezoid whose upper base is shorter than a lower base,
the first light guide includes a first surface facing the reflector and a second surface facing the second light guide,
the first surface includes a plurality of first protruding portions formed thereon,
the second surface includes a plurality of second protruding portions formed thereon,
each of the plurality of first protruding portions has a cross-sectional shape of a first triangle projecting downward,
each of the plurality of first protruding portions has a first base angle, a second base angle, and a first apex angle,
each of the plurality of second protruding portions has a cross-sectional shape of a second triangle projecting upward,
each of the plurality of second protruding portions has a third base angle, a fourth base angle, and a second apex angle, and
the third base angle is larger than the first base angle.

According to another embodiment, an illumination device comprises
a first light guide including a first edge and a second edge;
a second light guide disposed on the first light guide and including a third edge and a fourth edge;
a plurality of light source elements disposed to face the third edge of the second light guide;
a reflector provided below the first light guide; and
an optical sheet provided on the second light guide,
wherein
the first light guide has a cross-sectional shape of a first trapezoid whose lower base thereof is shorter than an upper base,
the second light guide has a cross-sectional shape of a second trapezoid whose upper base thereof is shorter than a lower base,
the first light guide includes a first surface facing the reflector and a second surface facing the second light guide,
the first surface includes a plurality of first protruding portions formed thereon,
the second surface includes a plurality of second protruding portions formed thereon,
each of the plurality of first protruding portions has a cross-sectional shape of a first triangle projecting downward,
each of the plurality of first protruding portions has a first base angle, a second base angle, and a first apex angle,
each of the plurality of second protruding portions has a cross-sectional shape of a second triangle projecting upward,
each of the plurality of second protruding portions has a third base angle, a fourth base angle, and a second apex angle, and
the third base angle and the first base angle are equal to each other.

According to still another embodiment, an illumination device comprises
a first light guide including a first edge and a second edge;
a second light guide disposed on the first light guide and including a third edge and a fourth edge;
a plurality of light source elements disposed to face the third edge of the second light guide;
a reflector provided below the first light guide; and
an optical sheet provided on the second light guide,
wherein
the first light guide has a cross-sectional shape of a first trapezoid whose lower base thereof is shorter than an upper base,
the second light guide has a cross-sectional shape of a second trapezoid whose upper base thereof is shorter than a lower base,
the first light guide includes a first surface facing the reflector and a second surface facing the second light guide,
the first surface includes a plurality of first protruding portions formed thereon,
the second surface includes a plurality of second protruding portions formed thereon,
each of the plurality of first protruding portions has a cross-sectional shape of a triangle projecting downward,
each of the plurality of first protruding portions has a first base angle, a second base angle, and a first apex angle,
each of the plurality of second protruding portions has a cross-sectional shape of a pentagon projecting upward,
each of the plurality of second protruding portions has a third base angle, a fourth base angle, a fifth base angle, a sixth base angle, and a second apex angle,
the fifth base angle is located between the third base angle and the second apex angle,
the sixth base angle is located between the fourth base angle and the second apex angle,
the third base angle and the first base angle are equal to each other, and
the fifth base angle is larger than the first base angle.

An object of this embodiment is to provide an illumination device with improved light extraction efficiency. With such an illumination device provided, another object is to provide a display device with high brightness.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of a display device with reference to the drawings.

In this embodiment, a first direction X, a second direction Y and a third direction Z are orthogonal to each other, but may intersect at an angle other than 90 degrees. The direction toward the tip of the arrow in the third direction Z is defined as up or above, and the direction opposite to the direction toward the tip of the arrow in the third direction Z is defined as down or below. Note that the first direction X, the second direction Y and the third direction Z may as well be referred to as an X direction, a Y direction and a Z direction, respectively.

With such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the illumination device on a tip side of the arrow in the third direction Z. Here, viewing from this observation position toward the X-Y plane defined by the first direction X and the second direction Y is referred to as plan view. Viewing a cross-section of the illumination device in the X-Z plane defined by the first direction X and the third direction Z or in the Y-Z plane defined by the second direction Y and the third direction Z is referred to as cross-sectional view.

### EMBODIMENT 1

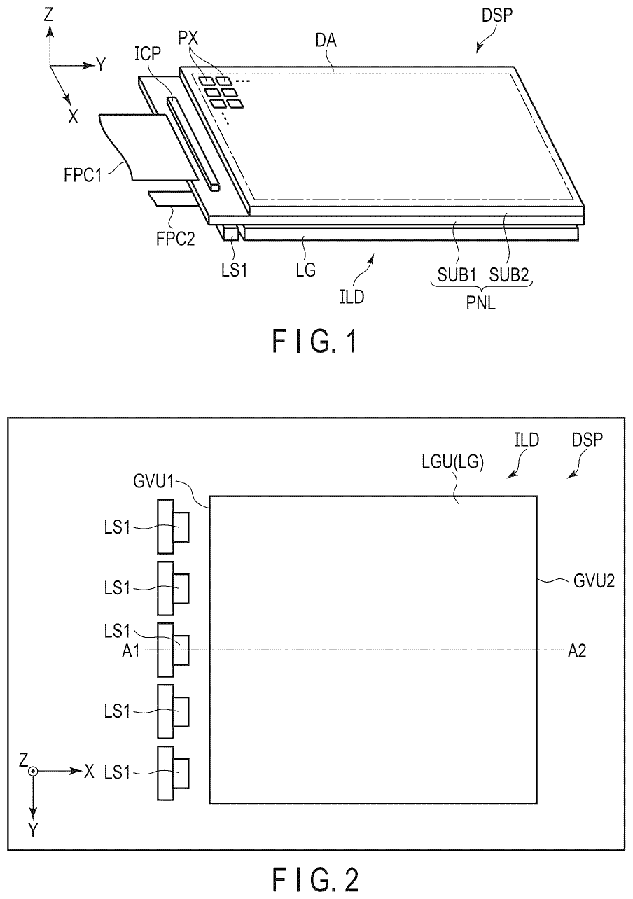

FIG. 1 is a perspective view schematically showing a configuration of a display device according to the embodiment. A display device DSP comprises a display panel PNL, an illumination device ILD, a drive IC chip ICP for driving the display panel PNL, a flexible printed circuit board FPC1 for supplying control signals to the display panel PNL, and a flexible printed circuit board FPC2 for supplying control signals to the illumination device ILD. For example, the flexible printed circuit board FPC1 and the flexible printed circuit board FPC2 may be connected to a control module that controls the operation of the display panel PNL and the illumination device ILD.

The display panel PNL comprises a substrate SUB1 (array substrate) and a substrate SUB2 (counter substrate) facing the substrate SUB1. The display panel PNL has a display area DA for displaying images. The display panel PNL comprises a plurality of pixels PX arranged in a matrix in the display area DA, for example.

The illumination device ILD includes a light source element LS1 and a light guide LG facing the substrate SUB1. The light source element LS1 faces one of side surfaces of the light guide LG. FIG. 1 shows one light source element LS1, but a plurality of light source elements LS1 may be provided.

In the configuration example shown in FIG. 1, the substrate SUB1, the substrate SUB2, and the light guide LG each have short edges along the first direction X and long edges along the second direction Y, and their shape in a plan view is rectangular. Note that the shapes of the substrate SUB1, the substrate SUB2, and the light guide LG are not limited to this; the shapes in a plan view may be some other shape such as square or circular.

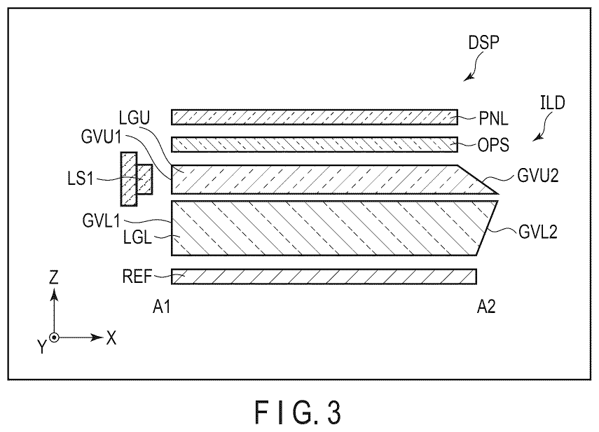

FIG. 2 is a plan view schematically showing a configuration of the display device. FIG. 3 is a cross-sectional view showing a cross-sectional structure of the display device taken along the line A1-A2 in FIG. 2.

The display device DSP comprises an illumination device ILD and a display panel PNL. The illumination device ILD comprises a reflector REF, a light guide LGL, a light guide LGU, an optical sheet OPS, and a light source element LS1. The reflector REF, the light guide LGL, the light guide LGU, and the optical sheet OPS are stacked in this order. When the light guide LGL and the light guide LGU are not particularly distinguished from each other, they are collectively referred to as light guides LG. The display panel PNL is provided on the illumination device ILD.

In a plan view, the edges extending along the second direction Y of the light guide LGU are designated as an edge GVU1 and an edge GVU2, respectively. In FIG. 2, the edge on the left side of the page is the edge GVU1, and the edge on the right side of the page is the edge GVU2. The light source element LS1 is provided at a position so face the edge GVU1 of the light guide LGU.

Although not shown in FIG. 2, the edge GVL1 of the light guide LGL is located below the edge GVU1 of the light guide LGU. The edge GVL2 of the light guide LGL is located below the edge GVU2 of the light guide LGU.

The light guide LGL has a rectangular shape in a plan view and a trapezoidal shape in a cross-sectional view, having a lower edge thereof shorter than an upper edge. The edge GVL1, which is a left side of this trapezoidal shape, extends along the third direction Z. The edge GVL2, which is a right side of this trapezoidal shape, extends to be inclined with respect to the third direction Z.

The light guide LGU has a rectangular shape in a plan view and a trapezoidal shape in a cross-sectional view, having a lower edge thereof longer than an upper edge. The edge GVU1, which is a left side of this trapezoidal shape, extends along the third direction Z. The edge GVU2, which is a right side of this trapezoidal shape, extends to be inclined with respect to the third direction Z.

The light source element LS is provided to face the edge GVU1 of the light guide LGU. Light emitted from the light source element LS is incident onto the edge GVU1 of the light guide LGU.

Note that the edges GVU1 and GVL1 are referred to as edges, but they are actually surfaces parallel to the Y-Z plane. The edge GVU2 and the edge GVL2 are actually surfaces inclined obliquely relative to the Y-Z plane.

On the main surfaces of the reflector REF, the light guide LGL, the light guide LGU, and the optical sheet OPS, a plurality of protruding portions (which may as well be referred to as prisms) are provided.

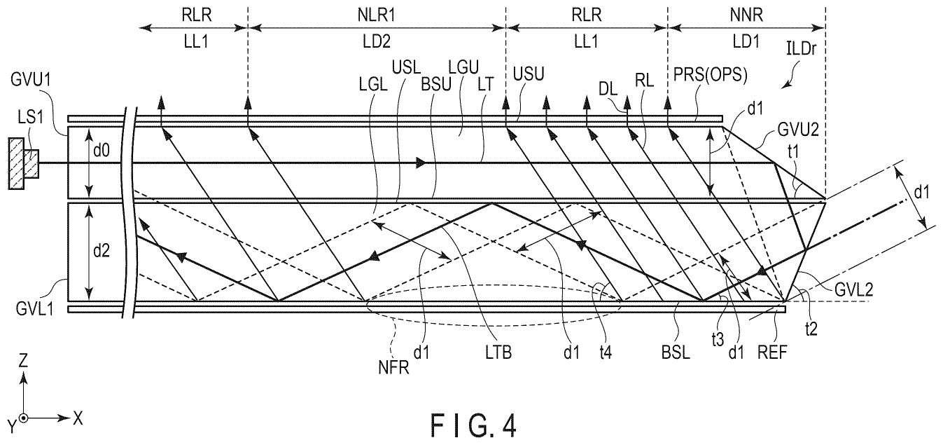

FIG. 4 is a cross-sectional view schematically showing a configuration of an illumination device of a comparative example. The illumination device ILDr shown in FIG. 4 comprises a reflector REF, a light guide LGL, a light guide LGU, a prism sheet PRS, and a light source element LS1. The optical sheet OPS shown in FIG. 3 corresponds to the prism sheet PRS shown in FIG. 4. Note here that the configuration of the optical sheet OPS is not limited to this, and it may as well include an optical sheet other than a prism sheet.

Of the main surfaces of the light guide LGL, the surface facing the reflector plate REF is designated as a surface BSL. Of the main surfaces of the light guide LGL, the surface facing the light guide LGU is designated as a surface USL. Of the main surfaces of the light guide LGU, the surface facing the light guide LGL is designated as a surface BSU. Of the main surfaces of the light guide LGU, the surface facing the prism sheet PRS is designated as a surface USU.

The thickness of the light guide LG (length along the third direction Z) is defined as a thickness d0. It is assumed here that the light beam width d1 is the same as the thickness d0 (d1=d0).

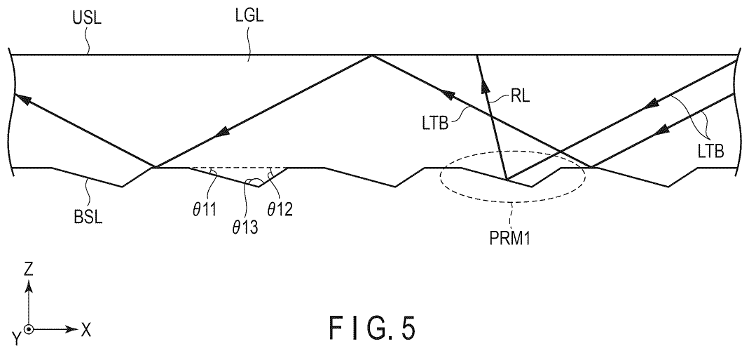

FIG. 5 is a cross-sectional view showing a protruding portion provided on the light guide LGL. On the surface BSL of the light guide LGL, a protruding portion PRM1 with a triangle shape protruding out downward (opposite to the third direction Z) is provided. On the other hand, no protruding portion is provided on the surface USL of the light guide LGL.

The protruding portion PRM1 is, as described above, a portion protruding out downward. Of the base angles of the protruding portion PRM1, the angle on the left side of the page is denoted as an angle θ11, and the angle on the right side of the page is denoted as an angle θ12. The apex angle of the protruding portion PRM1 is denoted as an angle θ13. The angles θ11, θ12, and θ13 may be different from each other. In the example shown in FIG. 5, the angle θ11 is smaller than the angle θ12.

The light source element LS1 is provided to face the edge GVU1 of the light guide LGU. The light LT emitted from the light source element LS1 enters from the surface containing the edge GVU1 of the light guide LGU and proceeds straight within the light guide LGU. The light LT having reached the edge GVU2 of the light guide LGU is reflected downward at the edge GVU2. The reflected light LT exits from the light guide LGU and enters the light guide LGL. The light entering the light guide LGL is denoted as light LTB. The light LTB entering the light guide LGL is reflected at the edge GVL2 of the light guide LGL and propagates in the opposite direction to the first direction X. At this time, the light LTB entering the light guide LGL propagates in the opposite direction to the first direction X between the surface BSL and surface USL of the light guide LGL while satisfying the condition for the total reflection.

Light LT and light LTB, having a beam width d1, propagate inside the light guide LGU and inside the light guide LGL. The light LTB, which has a beam width d1 and is reflected at the surface BSL of the light guide LGL, is emitted upward by a protruding portion (prism) provided on the surface BSL. This emitted light is designated as light RL. The light RL is emitted upward from the surface USU of the light guide LGU and enters the prism sheet PRS. The light RL is further emitted upward from the illumination device ILD as light DL, emitted along the third direction Z by the prism sheet PRS.

The acute angle formed by the surface BSU and the edge GVU2 is denoted as an angle t1. The acute angle formed by a virtual line extending the surface BSL along the first direction X and the edge GVL2 is denoted as an angle t2. The angle at which the light LTB is incident on the surface BSL is denoted as an angle t3. The angle formed by the surface BSL and the light RL is denoted as an angle t4.

Here, note that even after reflecting off the surface BSL of the light guide LGL, part of the light LTB does not exit upward from the surface BSL, but is totally reflected at the surface USL and returns to the light guide LGL. The light LTB, after undergoing total reflection at the surface USL and returning to the light guide LGL, is totally reflected again at the surface BSL. Thus, the light LTB is guided inside the light guide LGL. When the amount of light LTB is large, there is a risk that the utilization efficiency of the light LTB entering from the light source element LS1 may be deteriorated.

The region from where the light LTB is reflected by the surface USL and therefore it is reflected by the surface BSL is defined as a region NFR. In the region NFR, the light LTB having a beam width d1 is not reflected, and therefore the light is not lifted upward.

The distance corresponding to the region NFR along the first direction X is defined as a distance (length) LD2. The distance of the region RLR, where the light DL is irradiated, along the first direction X is defined as a distance (length) LL1. No light irradiation occurs between the end portion of the light guide LGU on the right side of the page and the region NNR close to the edge GVU2, where the light DL is irradiated. The distance of the region NNR along the first direction X is defined as a distance (length) LD1. The region located between each adjacent pair of regions RLR, where the light DL is not irradiated, is defined as a region NLR1. The distance of the region NLR1 along the first direction X is defined as a distance (length) LD2.

The distances LL1, LD1, and LD2 are expressed by the following equations.

LL1=d2((1/tan t3)−(1/tan t2)). (Equation 1)

LD1=(d2/tan t2)+((d0+d2)/tan t4) (Equation 2)

LD2=d2((1/t3)+(1/t2)) (Equation 3)

t3=2t1+2t2−180° (Equation 4)

t4=t3+2θ11 (Equation 5)

For example, the thickness d0 is 0.54 [mm] (d0=0.54), and the thickness d2 is 1 [mm] (d2=1). The angle t1 is 35.25 ° (t1=35.25°), the angle t2 is 68 ° (t2=68°), and angle θ11 is 15 ° (θ11=15°).

At this time, from (Equation 1) and (Equation 4), the distance LL1 is 1.60 [mm] (LL1=1.60). From (Equation 2), (Equation 4), and (Equation 5), the distance LD1 is 1.42 [mm] (LD1=1.42). From (Equation 3) and (Equation 4), the distance LD2 is 2.41 [mm] (LD2=2.41).

In the embodiment, the protruding portion (prism) is provided on the surface USL of the light guide LGL as well, and with this configuration, the light LTB guided inside the light guide LGL can be emitted upward.

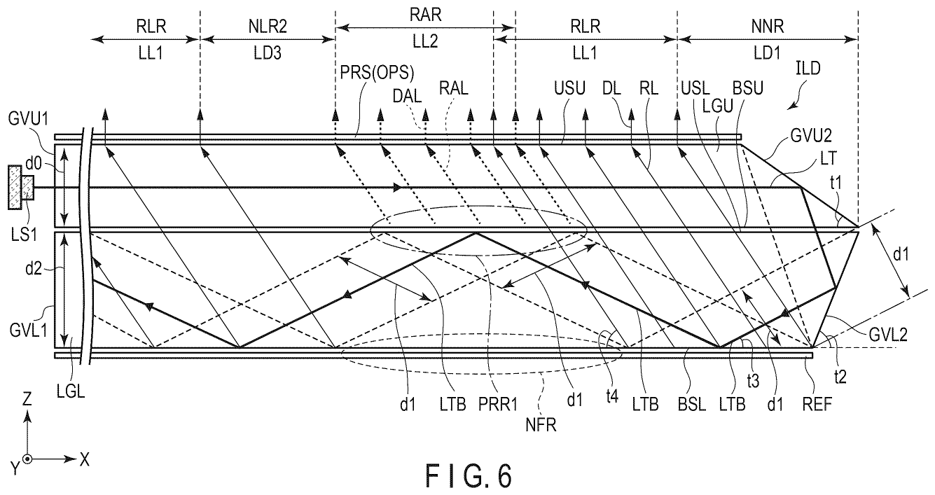

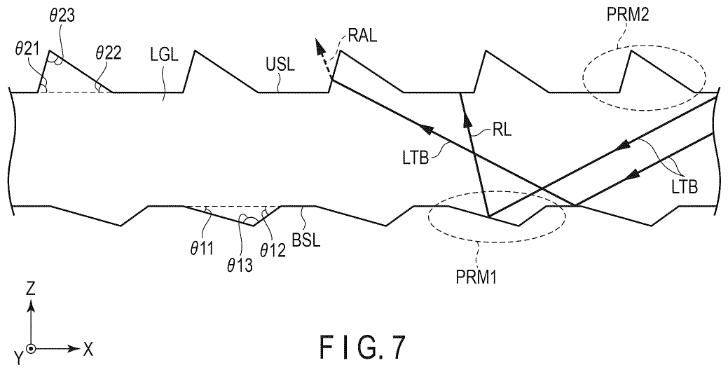

FIG. 6 is a cross-sectional view schematically showing a configuration of the illumination device of the embodiment. The illumination device ILD shown in FIG. 6 is different from the illumination device ILD shown in FIG. 4 in that a plurality of protruding portions PRM2 are provided on the surface USL of the light guide LGL. FIG. 7 is a cross-sectional view showing the protruding portions provided on the light guide LGL.

As shown in FIG. 7, the light guide LGL has not only the protruding portions PRM1 on the surface BSL, but also the protruding portions PRM2 on the surface USL. The protruding portions PRM2 are upwardly protruding portions with a triangle shape. Of the base angles of the protruding portion PRM2, the angle on the left side of the page is denoted as an angle θ21, and the angle on the right side of the page is denoted as an angle θ22. The apex angle of the protruding portion PRM2 is denoted as an angle θ23. The angles θ21, θ22, and θ23 may be different from each other. In the example shown in FIG. 7, the angle θ21 is larger than the angle θ22. Further, the angle θ21 of the protruding portion PRM2 is larger than the angle θ11 of the protruding portion PRM1. The angle θ23 of the protruding portion PRM2 is larger than the angle θ13 of the protruding portion PRM1.

As shown in FIG. 6, and as in the case of FIG. 4, the light LT emitted from the light source element LS1 enters from the surface containing the edge GVU1 of the light guide LGU and propagates inside the light guide LGU. The light LT reaching the edge GVU2 of the light guide LGU is reflected downward at the surface containing the edge GVU2. The reflected light LT exits from the light guide LGU and enters the light guide LGL. The light LTB entering the light guide LGL is reflected at the surface containing the edge GVL2 of the light guide LGL and propagates in the opposite direction to the first direction X.

The light LTB reflected at the surface BSL of the light guide LGL is emitted upward by a protruding portion (prism) provided on the surface BSL. This emitted light RL exits from the surface USU of the light guide LGU and enters the prism sheet PRS. The light RL is further emitted upward from the illumination device ILD by the prism sheet PRS as light DL propagating along the third direction Z.

As described in FIG. 4, the light LTB does not exit upward from the surface BSL but reflects at the surface USL and returns to the light guide LGL. The light LTB undergoes total reflection at the surface USL, and returns to inside the light guide LGL, and then is totally reflected again at the surface BSL. The light LTB reflected at the surface BSL propagates toward the surface USL.

The light LTB reaching the surface USL is emitted upward by the protruding portions PRM2 provided on the surface USL. This emitted light is referred to as light RAL. The light RAL is emitted from the surface USU of the light guide LGU and enters the prism sheet PRS. The light RAL is further emitted upward from the illumination device ILD by the prism sheet PRS as light DAL, emitted along the third direction Z.

In the example shown in FIG. 6, the region NFR already exists. But because the protruding portions PRM2 are provided on the surface USL, the light LTB is emitted upward in the region PRR1 of the surface USL. With this configuration, the light LTB propagating through the light guide LGL can be efficiently extracted.

The region where the light DAL is irradiated is defined as a region RAR. The distance of the region RAR along the first direction X is defined as a distance (length) LL2. The region located between the regions where the light DL and light DAL are irradiated, and where the light DL and the light DAL are not irradiated, is defined as a region NLR2. The distance of the region NLR2 along the first direction X is defined as a distance (length) LD3.

The distance LL2 is expressed by the following equation.

LL2=d2 ((1/tan t3)−(1/tan t4)) (Equation 6)

As in the case of FIG. 4, in FIG. 6 as well, for example, the thickness d0 is 0.54 [mm] (d0=0.54), and the thickness d2 is 1 [mm] (d2=1). The angle t1 is 35.25° (t₁=35.25°), the angle t2 is 68 ° (t2=68°), and the angle θ11 is 15° (θ11=15°). The angle θ21 is 78.5° (θ21=78.5°).

At this time, from (Equation 1) and (Equation 4), the distance LL1 is 1.60 [mm] (LL1 =1.60). From (Equation 4), (Equation 5), and (Equation 6), the distance LL2 is 1.34 [mm] (LL2 =1.34).

In the example shown in FIG. 6, a part of the region RAR overlaps with the region RLR. Note here that the embodiment is not limited to this. The region RAR may be disposed to be apart from the region RLR without overlapping therewith. Further, the entire region RAR may overlap with the region RLR. The positions of the region RLR and region RAR with respective to each other can be controlled by varying the angles of the edge GVU2 and the edge GVL2 relative to the X-Y plane, the angles θ21, θ22, and θ23 of the protruding portion PRM2, the refractive indices of the light guide LGU and light guide LGL and the like.

With the embodiment, it is possible to provide an illumination device having improved light extraction efficiency. With such an illumination device thus provided, a display device having high brightness can be obtained.

### CONFIGURATION EXAMPLE 1

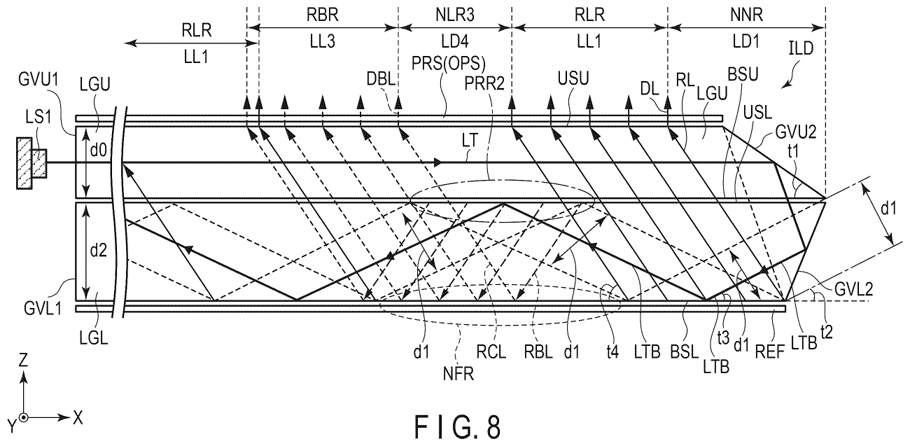

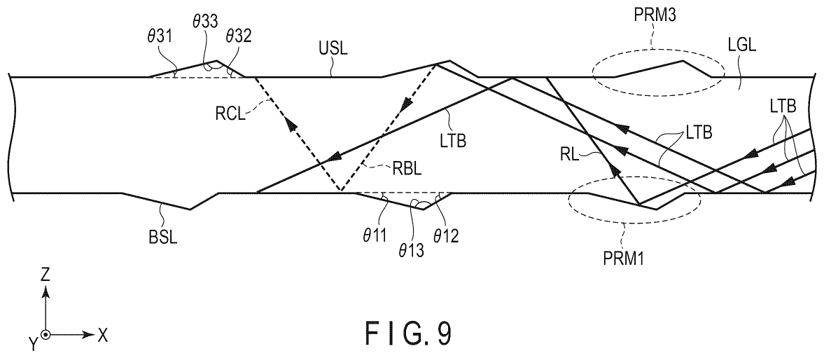

FIG. 8 is a cross-sectional view showing another configuration example of the illumination device in the embodiment. The configuration example shown in FIG. 8 is different from the configuration example shown in FIG. 6 in that it has a protruding portion (prism) that reflects light downward. FIG. 9 is a cross-sectional view showing the protruding portion provided on the light guide LGL.

As shown in FIG. 9, not only the protruding portion PRM1 on the surface BSL, but also the protruding portion PRM3 on the surface USL are provided on the light guide LGL. The protruding portion PRM3 is an upwardly protruding portion with a triangle shape. Of the base angles of the protruding portion PRM3, the angle on the left side of the page is denoted as an angle θ31, and the angle on the right side of the page is denoted as an angle θ32. The apex angle of the protruding portion PRM3 is denoted as an angle θ33. The angles θ31, θ32, and θ33 may be different from each other. In the example shown in FIG. 9, the angle θ31 is smaller than the angle θ32.

In Configuration Example 1, the protruding portion PRM1 and protruding portion PRM3 are disposed in a line-symmetric relationship with respect to the first direction X. The angle θ11 of the protruding portion PRM1 and the angle θ31 of the protruding portion PRM3 are equal to each other. The angle θ12 of the protruding portion PRM1 and the angle θ32 of the protruding portion PRM3 are equal to each other. The angle θ13 of the protruding portion PRM1 and the angle θ33 of the protruding portion PRM3 are equal to each other.

The region PRR1 shown in FIG. 6 is referred to as a region PRR2 in FIG. 8. The light LTB reaching the region PRR2 is emitted downward by a protruding portion PRM3 provided in the region PRR2. This downwardly emitted light is designated as light RBL. The light RBL enters the region NFR.

The region NFR, as explained in FIG. 4, is a region into which the light LTB having a beam width d1 does not enter. In FIG. 8, the light RBL enters the region NFR as well. The light RBL is emitted upward by the protruding portion PRM1 provided in the region NFR (surface BSL). This upwardly emitted light is referred to as light RCL.

The light RCL, as well as the light RL, is emitted upward from the surface USU of the light guide LGU and enters the prism sheet PRS. The light RCL is further emitted upward from the illumination device ILD by the prism sheet PRS as light DBL, which is emitted along the third direction Z.

In Configuration Example 1, the light LTB propagating through the light guide LGL is reflected downward by the protruding portion PRM3 provided on the surface USL. The downwardly reflected light RBL is emitted upward by the protruding portion PRM1 provided on the surface BSL. It is further emitted upward from the illumination device ILD as light DBL. With this configuration, the light LTB propagating through the light guide LGL can be efficiently extracted.

The region where the light DBL is irradiated is defined as a region RBR. The distance of the region RBR along the first direction X is defined as a distance (length) LL3. The region located between the regions where the light DL and light DBL are irradiated, and where the light DL and light DBL are not irradiated, is defined as a region NLR3. The distance of the region NLR3 along the first direction X is defined as a distance (length) LD4.

The distance LL3 is expressed by the following equation.

LL3=d2 ((1/tant3)−(1/tant4)) (Equation 7)

As well as FIG. 4, in FIG. 8, for example, the thickness d0 is 0.54 [mm] (d0=0.54), and the thickness d2 is 1 [mm] (d2=1). The angle t1 is 35.25 ° (t1=35.25°), the angle t2 is 68 ° (t2=68°), and the angle θ11 is 15 ° (θ11=15°). The angle θ31 is 15 ° (θ31=15°).

At this time, from (Equation 1) and (Equation 4), the distance LL1 is 1.60 [mm] (LL1 =1.60). From (Equation 4), (Equation 5), and (Equation 7), the distance LL3 is 1.34 [mm] (LL3=1.34).

In the example shown in FIG. 8, part of the region RBR overlaps with the region RLR. Note that the embodiment is not limited to this. The region RBR may be disposed apart from the region RLR without overlapping therewith. Alternatively, the entire region RBR may overlap with the region RLR. The positions of the region RLR and region RBR can be controlled by varying the angles of the edge GVU2 and the edge GVL2 relative to the X-Y plane, the angles θ21, θ22, and θ23 of the protruding portion PRM2, the refractive indices of the light guides LGU and LGL, and the like.

With Configuration Example 1, an illumination device with improved light extraction efficiency can be obtained. With such an illumination device thus provided, a display device having high brightness can be obtained.

### CONFIGURATION EXAMPLE 2

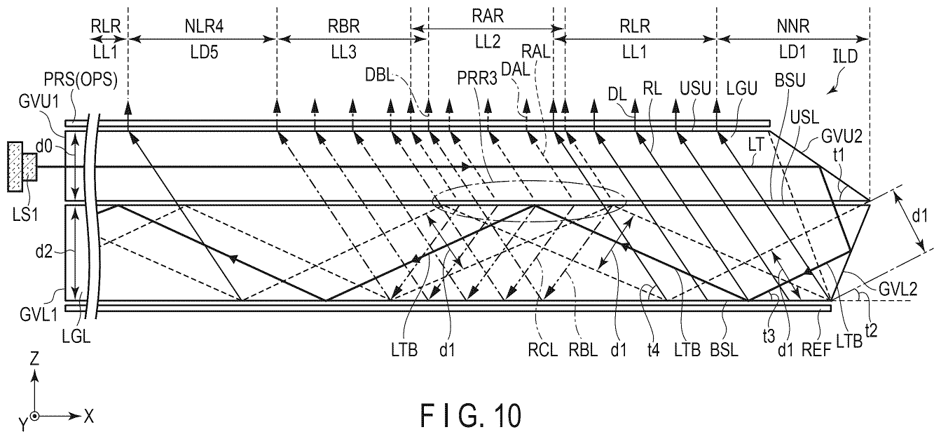

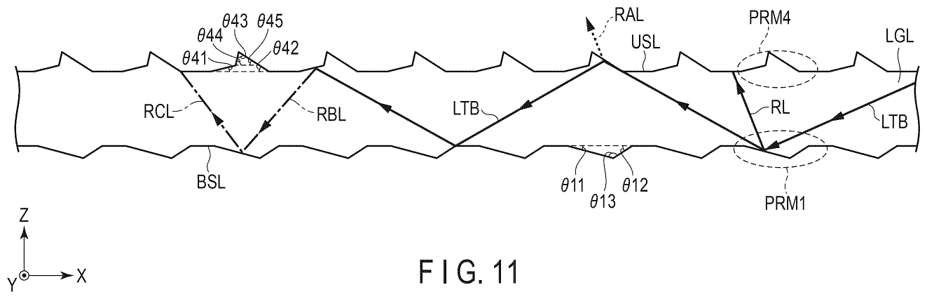

FIG. 10 is a cross-sectional view showing another configuration example of the illumination device in the embodiment. The configuration example shown in FIG. 10 is different from the configuration example shown in FIG. 6 in that it has a protruding portion (prism) that reflects light downward and a protruding portion (prism) that emits light upward. FIG. 11 is a cross-sectional view showing the protruding portions provided on the light guide LGL.

As shown in FIG. 11, the light guide LGL has a protruding portion PRM1 on the surface BSL and a protruding portion PRM4 on the surface USL. The protrusion portion PRM4 is an upwardly protruding portion. The cross-sectional shape of the protruding portion PRM4 is pentagonal, which may be obtained by stacking two triangles vertically one on another.

Of the base angles of the protruding portion PRM4, the angle on the left side of the page is denoted as an angle θ41, and the angle on the right side of the page is denoted as an angle θ42. The apex angle of the protruding portion PRM4 is denoted as an angle θ43. The angle located between the angles θ41 and θ43 is denoted as an angle θ44. The angle located between the angles θ42 and θ43 is denoted as an angle θ45. The angles θ41, θ42, θ43, θ44, and θ45 may be different from each other.

The angles θ41 and θ11 should only be the same. The angles θ42 and θ12 should only be the same. With the angles θ41 and θ42 of such configurations, the protruding portion PRM4 can reflect the light LTB and obtain the light RBL emitted downward, as well as in the case of the protruding portion PRM3.

The angle θ44 should only be greater than the angle θ11. With the angle θ44 of such a configuration, the protruding portion PRM4 can create the light RAL emitted upward from the light LTB, as well as in the case of the protruding portion PRM2.

The triangular shape formed by the angles θ43, θ44, and θ45 should only be the same as the triangular cross-sectional shape of the protruding portion PRM2 shown in FIG. 7. The virtual triangular shape including the angles θ41 and θ42 should only be the same as the triangular cross-sectional shape of the protruding portion PRM3 shown in FIG. 9.

Note that in FIG. 11, the location where the light RAL is emitted upward by the protruding portion PRM4 and the location where the light RBL is emitted downward by the protruding portion PRM4 are shown at different places. However, as shown in FIG. 10, the light LTB has a beam width d1, and therefore the light RAL and light RBL are emitted upward and downward, respectively, from the same position.

The region PRR1 shown in FIG. 6 is referred to as a region PRR3 in FIG. 10. The light RAL emitted upward and the light RBL emitted downward are generated from the light LTB reaching the region PRR3 by the protruding portions PRM4 provided in the region PRR3.

The light RAL enters the light guide LGU and is emitted from the surface USU of the light guide LGU. The light RAL enters the prism sheet PRS. The light RAL is further emitted from the illumination device ILD by the prism sheet PRS as light DAL emitted along the third direction Z.

The light RBL is emitted downward by the protruding portion PRM4, then emitted upward as the light RCL by the protruding portion PRM1 provided on the surface BSL.

The light RCL is emitted upward from the surface USU of the light guide LGU and enters the prism sheet PRS. The light RCL is further emitted upward from the illumination device ILD by the prism sheet PRS as light DBL, emitted along the third direction Z.

In configuration example 2, with the protruding portions PRM4 provided on the surface USL, the light LTB propagating through the light guide LGL is reflected upward and downward. The light RAL emitted upward is emitted from the illumination device ILD as the light DAL. The light RBL reflected downward is emitted upward by the protruding portion PRM1 provided on the surface BSL. It is further emitted upward from the illumination device ILD as the light DBL. With this configuration, the light LTB propagating through the light guide LGL can be efficiently extracted.

The distance (length) LL1, the distance (length) LL2, and the distance (length) LL3 are set similar to those described above. The distance (length) LD5 is defined as the distance of the region NLR4 along the first direction X, which is located between the regions where the light DL and light DBL are irradiated, respectively, and where the light DL, light DAL, and light DBL are not irradiated.

As well as in the case of FIG. 4, in FIG. 10, for example, the thickness d0 is 0.54 [mm] (d0=0.54), and the thickness d2 is 1 [mm] (d2=1). The angle t1 is 35.25° (t1=35.25°), the angle t2 is 68° (t2=68°), and the angle θ11 is 15° (θ11=15°). The angle θ44 is 78.5° (θ21=78.5°). The angle θ41 is 15° (θ31=15°).

At this time, from (Equation 1) and (Equation 4), the distance LL1 is 1.60 [mm] (LL1=1.60). From (Equation 4), (Equation 5), and (Equation 6), the distance LL2 is 1.34 mm (LL2=1.34). From (Equation 4), (Equation 5), and (Equation 7), the distance LL3 is 1.34 mm (LL3=1.34).

In the example shown in FIG. 10, a part of the region RAR overlaps with the region RLR. A part of the region RBR overlaps with the region RAR. Note that the embodiment is not limited to this. The region RAR may be disposed apart from the region RLR without overlapping therewith. Alternatively, the entire region RAR may overlap the region RLR. The region RBR may be disposed apart from the region RAR without overlapping therewith. Or, the entire region RBR may overlap the region RAR.

The positions of the regions RLR, RAR, and RBR with respect to each other can be controlled by varying the angles of the edges GVU2 and GVL2 relative to the X-Y plane, the angles θ41, θ42, θ43, θ44, and θ45 of the protruding portions PRM4, and the refractive indices of the light guides LGU and LGL.

With Configuration Example 2, an illumination device with improved light extraction efficiency can be obtained. With the illumination device having such a configuration, a display device with high brightness can be obtained.

### Configuration Example 3

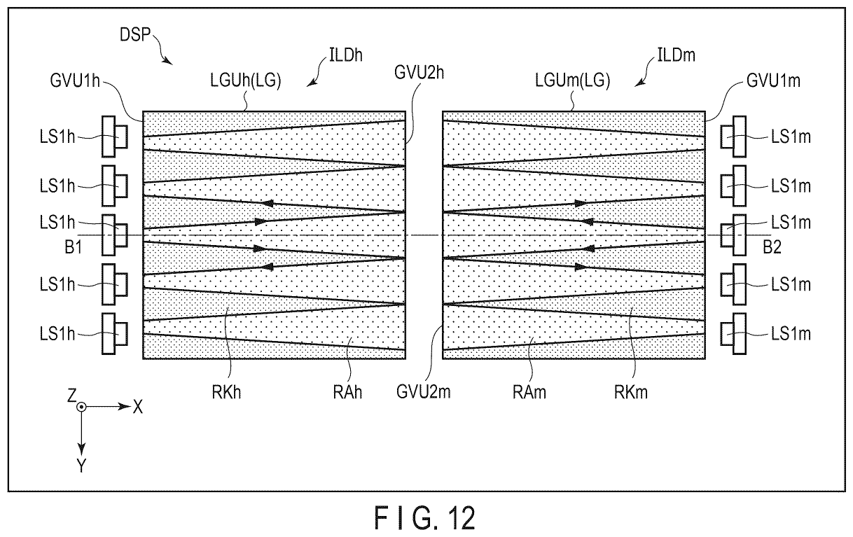

FIG. 12 is a plan view illustrating an example of an application of the illumination device. The display device DSP shown in FIG. 12 includes an illumination device ILDh for the left eye and an illumination device ILDh for the right eye.

The illumination device ILDh for the left eye has a configuration similar to the illumination device ILD shown in FIG. 2. In FIG. 12, the illumination device ILDh comprises a light guide LGUh and a plurality of light source elements LS1h. In a plan view, the edges of the light guide LGUh, which extend along the second direction Y are designated as an edge GVU1h and an edge GVU2h, respectively. In FIG. 12, the edge on the left side of the page is designated as the edge GVU1h, and the edge on the right side of the page is designated as the edge GVU2h. The light source elements LS1h are located at respective positions facing the edge GVU1h of the light guide LGUh.

The illumination device ILDm for the right eye is disposed line symmetrically with respect to the second direction Y relative to the illumination device ILDh. As shown in FIG. 12, the illumination device ILDm comprises a light guide LGUm and a plurality of light source elements LS1m. In a plan view, the edges of the light guide LGUm, which extend along the second direction Y are designated as an edge GVU1m and an edge GVU2m, respectively. In FIG. 12, the edge on the right side of the page is referred to as the edge GVU1m, and the edge on the left side of the page is referred to as the edge GVU2m. The light source elements LS1m are provided at respective positions facing the edge GVU1m of the light guide LGUm.

As shown in FIG. 12, for example, the light emitted from the light source elements LS1h (corresponding to light LT), and the light emitted upward after being reflected by the edge GVU2h of the light guide LGUh and the edge GVL2h of the light guide LGLh (corresponding to light DL, light DAL, and light DBL) are synthesized. With this configuration, bright regions RAh and dark regions RKh are formed on the light guide LGUh. The width of each bright region RAh becomes narrower as the location is closer to the respective light source element LS1h. The width of each bright region RAh becomes wider as the location is farther away from the respective light source element LS1h.

Similarly, the light emitted from the light source elements LS1m, and the light reflected at the edge GVU2m of the light guide LGUm and the edge GVL2m of the light guide LGLm before being emitted upward, are synthesized. With this configuration, bright regions RAm and dark regions RKm are created in the light guide LGUm. The width of each bright region RAm becomes narrower as the location is closer to the respective light source element LS1m. The width of each bright region RAm becomes wider as the location is farther away from the respective light source element LS1m.

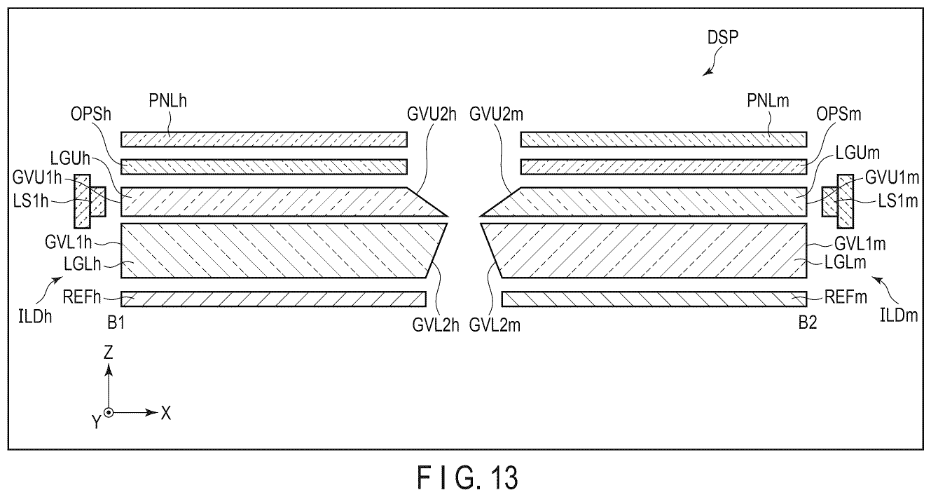

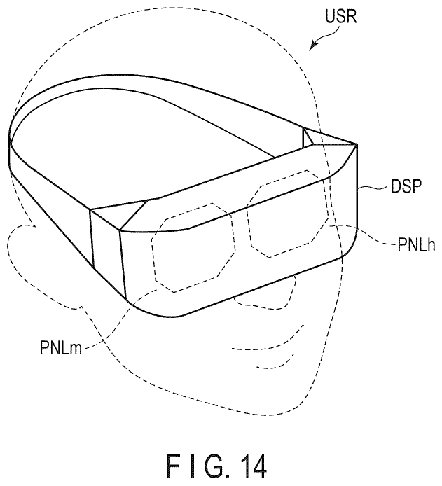

FIG. 13 is a cross-sectional view showing the cross-sectional structure of the display device taken along the line B1-B2 in FIG. 12. The display device DSP comprises an illumination device ILDh, a display panel PNLh, an illumination device ILDm, and a display panel PNLm. The display panel PNLh is provided on the illumination device ILDh. The display panel PNLm is provided on the illumination device ILDm.

The illumination device ILDh and display panel PNLh have configurations similar to those of the illumination device ILD and display panel PNL shown in FIG. 3. The illumination device ILDm and display panel PNLm are provided symmetrically with respect to the Y-Z plane relative to the illumination device ILDh and display panel PNLh.

The illumination device ILDh comprises a reflector REFh, a light guide LGLh, a light guide LGUh, an optical sheet OPSh, and a light source element LS1h. The reflector REFh, light guide LGLh, light guide LGUh, and optical sheet OPSh are stacked in this order.

The light guide LGUh has an edge GVU1h and an edge GVU2h. The edge GVU1h is located on the left side of the page and faces the light source element LS1h. The edge GVU2h is located on the right side of the page and faces the edge GVU2m of the light guide LGUm.

The light guide LGLh has an edge GVL1h and an edge GVL2h. The edge GVL1h is located on the left side of the page and is aligned with the edge GVU1h of the light guide LGU along the third direction Z. The edge GVL2h is located on the right side of the page and faces the edge GVL2m of the light guide LGLm.

The illumination device ILDm comprises a reflector REFm, a light guide LGLm, a light guide LGUm, an optical sheet OPSm, and a light source element LS1m. The reflector REFm, light guide LGLm, light guide LGUm, and optical sheet OPSm are stacked in this order.

The light guide LGUm has an edge GVU1m and an edge GVU2m. The edge GVU1m is located on the right side of the page and faces the light source element LS1m. The edge GVU2m is located on the left side of the page and faces the edge GVU2h of the light guide LGUh.

The light guide LGLm has an edge GVL1m and an edge GVL2m. The edge GVL1m is located on the right side of the page and is aligned with the edge GVU1m of the light guide LGUm along the third direction Z. The edge GVL2m is located on the left side of the page and faces the edge GVL2h of the light guide LGLh.

The cross-sectional shape of each of the light guide LGLh and light guide LGLm is trapezoidal in which the lower base is shorter than the upper base. The cross-sectional shape of each of the light guide LGUh and light guide LGUm is trapezoidal in which the upper base is shorter than the lower base.

For the illumination device ILDh and illumination device ILDm, the illumination device ILD described above may be used. That is, on the light guide LGLh and light guide LGLm, protruding portion PRM2, PRM3, or PRM4 is provided. More specifically, for the illumination device ILDh including the light guide LGLh, a configuration similar to that of the illumination device ILD described above may be used. On the other hand, for the illumination device ILDm including the light guide LGLm, it suffices if it has a configuration that is left-right symmetrical with respect to the Y-Z plane compared to the above-described illumination device ILD.

FIG. 14 is a perspective view showing an example of the appearance of the display device according to Configuration Example 3. In Configuration Example 3, the display device DSP includes a head-mounted display (HMD), which is mounted on the head of the user when used. The display device DSP having such a configuration is used to provide, for example, virtual reality (VR) to a user USR wearing the display device DSP on the head.

The display panel PNLh and the display panel PNLm are respectively disposed so that they are located in front of the left eye and right eye, respectively, of the user USR when the user USR has the display device DSP mounted on the head.

As described above, with the illumination devices with high light extraction efficiency, it is possible to obtain a display device with high brightness.

In this disclosure, the light guide LGL and the light guide LGU may as well be referred to as the first light guide and the second light guide, or the lower light guide and the upper light guide, respectively. The edge GVL1 and the edge GVL2 of the light guide LGL may as well be referred to as the first edge and the second edge, respectively. The edge GVU1 and the edge GVU2 of the light guide LGU may as well be referred to as the third edge and the fourth edge, respectively.

The surface BSL of the light guide LGL may as well be referred to as the first surface, and the surface USL may be referred to as the second surface. The protruding portion PRM1 may be referred to as the first protruding portion, and the protruding portion PRM2, PRM3, or PRM4 may be referred to as the second protruding portion. The cross-sectional shape of the protruding portion PRM1 may be triangular. The angles θ11, θ12, and θ13 of the protruding portion PRM1 may be referred to as the first base angle, the second base angle, and the first apex angle, respectively.

The cross-sectional shape of the protruding portion PRM2 and protruding portion PRM3 may be triangular. The cross-sectional shape of the protruding portion PRM4 is pentagonal. That is, the cross-sectional shape of the protruding portion PRM2, PRM3, or PRM4 is polygonal.

The angles θ21, θ22, and θ23 of the protruding portion PRM2 may be referred to as the third base angle, the fourth base angle, and the second apex angle, respectively. The angles θ31, θ32, and θ33 of the protruding portion PRM3 may be referred to as the third base angle, the fourth base angle, and the second apex angle, respectively. The angles θ41, θ42, θ43, θ44, and θ45 of the protruding portion PRM4 may be referred to as the third base angle, the fourth base angle, the second apex angle, the fifth base angle, and sixth base angle, respectively.

The cross-sectional shape of the light guide LGL may be referred to a first trapezoid having a lower edge thereof shorter than an upper edge. The cross-sectional shape of the light guide LGU may be referred to a second trapezoid having a lower edge thereof longer than an upper edge. The cross-sectional shape of the protruding portion PRM1 may be referred to a first triangle protruding out downward. Each of the cross-sectional shapes of the protruding portions PRM2 and PRM3 may be referred to a second triangle protruding out upward.

Note that the ordinal numbers assigned to the edges and angles are not limited to those listed above. Different ordinal numbers may be assigned as necessary.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is

1. An illumination device comprising:
a first light guide including a first edge and a second edge;
a second light guide disposed on the first light guide and including a third edge and a fourth edge;
a plurality of light source elements disposed to face the third edge of the second light guide;
a reflector provided below the first light guide; and
an optical sheet provided on the second light guide,
wherein
the first light guide has a cross-sectional shape of a first trapezoid whose lower base thereof is shorter than an upper base,
the second light guide has a cross-sectional shape of a second trapezoid whose upper base is shorter than a lower base,
the first light guide includes a first surface facing the reflector and a second surface facing the second light guide,
the first surface includes a plurality of first protruding portions formed thereon,
the second surface includes a plurality of second protruding portions formed thereon,
each of the plurality of first protruding portions has a cross-sectional shape of a first triangle projecting downward,
each of the plurality of first protruding portions has a first base angle, a second base angle, and a first apex angle,
each of the plurality of second protruding portions has a cross-sectional shape of a second triangle projecting upward,
each of the plurality of second protruding portions has a third base angle, a fourth base angle, and a second apex angle, and
the third base angle is larger than the first base angle.

2. The illumination device according to claim 1, wherein
the second apex angle is larger than the first apex angle.

3. A display device comprising:
the illumination device according to claim 1, and
a display panel provided on the illumination device.

4. An illumination device comprising:
a first light guide including a first edge and a second edge;
a second light guide disposed on the first light guide and including a third edge and a fourth edge;
a plurality of light source elements disposed to face the third edge of the second light guide;
a reflector provided below the first light guide; and
an optical sheet provided on the second light guide,
wherein
the first light guide has a cross-sectional shape of a first trapezoid whose lower base thereof is shorter than an upper base,
the second light guide has a cross-sectional shape of a second trapezoid whose upper base thereof is shorter than a lower base,
the first light guide includes a first surface facing the reflector and a second surface facing the second light guide,
the first surface includes a plurality of first protruding portions formed thereon,
the second surface includes a plurality of second protruding portions formed thereon,
each of the plurality of first protruding portions has a cross-sectional shape of a first triangle projecting downward,
each of the plurality of first protruding portions has a first base angle, a second base angle, and a first apex angle,
each of the plurality of second protruding portions has a cross-sectional shape of a second triangle projecting upward,
each of the plurality of second protruding portions has a third base angle, a fourth base angle, and a second apex angle, and
the third base angle and the first base angle are equal to each other.

5. The illumination device according to claim 4,
wherein
the fourth base angle and the second base angle are equal to each other, and
the second apex angle and the first apex angle are equal to each other.

6. A display device comprising:
the illumination device according to claim 4; and
a display panel provided on the illumination device.

7. An illumination device comprising:
a first light guide including a first edge and a second edge;
a second light guide disposed on the first light guide and including a third edge and a fourth edge;
a plurality of light source elements disposed to face the third edge of the second light guide;
a reflector provided below the first light guide; and
an optical sheet provided on the second light guide,
wherein
the first light guide has a cross-sectional shape of a first trapezoid whose lower base thereof is shorter than an upper base,
the second light guide has a cross-sectional shape of a second trapezoid whose upper base thereof is shorter than a lower base,
the first light guide includes a first surface facing the reflector and a second surface facing the second light guide,
the first surface includes a plurality of first protruding portions formed thereon,
the second surface includes a plurality of second protruding portions formed thereon,
each of the plurality of first protruding portions has a cross-sectional shape of a triangle projecting downward,
each of the plurality of first protruding portions has a first base angle, a second base angle, and a first apex angle,
each of the plurality of second protruding portions has a cross-sectional shape of a pentagon projecting upward,
each of the plurality of second protruding portions has a third base angle, a fourth base angle, a fifth base angle, a sixth base angle, and a second apex angle,
the fifth base angle is located between the third base angle and the second apex angle,
the sixth base angle is located between the fourth base angle and the second apex angle,
the third base angle and the first base angle are equal to each other, and
the fifth base angle is larger than the first base angle.

8. The illumination device according to claim 7, wherein
the fourth base angle and the second base angle are equal to each other.

9. A display device comprising:
the illumination device according to claim 7, and
a display panel provided on the illumination device.
